(19) United States
(12) Patent Application Publication
(10) Pub. No.: US 2009/0233628 A1
(43) Pub. Date: Sep. 17, 2009

(54) DEVICE AND METHOD IN A COMMUNICATION SYSTEM

(75) Inventor: Mattias VENDEL, Malmo (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/048,686

(22) Filed: Mar. 14, 2008

(51) Int. Cl. H04Q 7/20

(52) U.S. Cl. 455/456.6

(57) ABSTRACT

The invention is directed towards a method in a first wireless communication device, for retrieving information data. The information data is retrieved from a remote data base accessible to a second communication device. The first wireless communication device and the second communication device are adapted to communicate with each other. The communication is made in a communication network. The method comprises the step of sending a request for retrieving information data. The request is sent to the second communication device. Also, the method comprises the step of receiving the requested information data from the second communication device.

### TECHNICAL FIELD

The present invention relates to a first wireless communication device, a method in a first wireless communication device, a second communication device, a method in a second communication device and computer programs. More particularly, the present invention relates to a mechanism for retrieving information data.

### BACKGROUND OF THE INVENTION

Portable electronic devices, such as cordless and cellular telephones, pagers, wireless modems, wireless email devices, personal digital assistants (PDAs) with communication functions and other portable electronic devices are becoming increasingly commonplace. Some of these portable electronic devices may be configured to communicate with other devices over a wireless communications network. Users of these portable electronic devices typically take these devices with them anywhere they go, which allows these users to, for example, place phone calls, listen to music, check an appointment on a calendar, watch a movie, check email and/or access the Internet and the information available thereon using the portable electronic device.

It may frequently occur that a first person e.g. when travelling far away, abroad, or to an otherwise unknown place, would like to retrieve information associated with that place. Such information may be contact information of nice and friendly local people living or at least being momentarily staying at the place in question. However, due to e.g. the first person's individual estrangement from the local community and other individuals in general as a reaction to the atomism of modern society, it may occur that he/she find no known people living there in his/her phone book.

It may further be a problem for the person residing in an unknown place to find local information, associated with that particular place, in particular if he/her is unable to communicate on the local language.

A possible solution may be to approach complete strangers in an attempt to ask information. However, the successfulness of achieving the requested information is often dependent on the time and availability of the approached local person. The described procedure also involves asking people on an individual basis, meaning that a plurality of people at once not could be reached in a practical way. Thus besides wasting the first persons own time, he/she also risk to waste other peoples time by the described inquiries. Further, such questioning may also be experienced as pure harassment by a sensitive second user, thus further reducing the willingness of cooperation of the second person, which is a sine qua non for a successful inquiry. Thus, the socially tactful person is likely to be very reluctant to use such an intrusive interrogation method towards strangers, which method may be perceived as very annoying, disturbing, irritating, aggravating and pestering by the recipient.

Another problem that may emerge when visiting a previously unknown site e.g. a city in a foreign country is that a user, who may not know anyone in the city in question, may want to come in contact with a friend, or at least a person to which he/she has some kind of connection e.g. a compatriot, who lives in that particular city.

A possible solution may be to look in the local telephone book and manually search for a person with a name sounding familiar or sounding likely to belong to a compatriot. However such search is likely to be experienced as tedious and time consuming to the average person. In cases where the local language is using an alphabet unfamiliar to the information searching person, even such simple information search as here described may be even impossible to perform.

In addition, as competition increases among manufacturers of communication devices, there is a marketing need for new functions and features.

### SUMMARY OF THE INVENTION

Embodiments of the present invention may provide an improved mechanism for facilitating the retrieval of information in a communication system.

One aspect provides a method performed by a wireless communication device. The method includes calculating the geographical position of the wireless communication device; sending a request to another wireless communication device, the request including an indication of the geographical position of the wireless communication device, an indication of a request category associated with the geographical position, and a trigger to automatically initiate a search of information accessible to the other wireless communication device; and receiving from the other wireless communication device the requested information associated with the calculated position.

Another aspect provides a wireless communication device including a geographical positioning unit adapted to determine the geographical position of the wireless communication device; a sending unit, adapted to send a request for information to at least one other wireless communication device, the request including an indication of the geographical position of the wireless communication device, an indication of a request category associated with the geographical position, and a trigger to automatically initiate a search of information accessible to the at least one other wireless communication device; and a receiving unit, adapted to receive the requested information from the at least one other wireless communication device.

Another aspect provides a method performed by a wireless communication device. The method includes receiving a request to provide information to another wireless communication device, the request including an indication of the geographical position of the other wireless communication device, an indication of a request category associated with the geographical position, and a trigger to initiate a search of information accessible to the wireless communication device; automatically searching for the requested information in response to receiving the trigger; extracting the requested information; and sending the requested information to the other wireless communication device.

A further aspect provides a wireless communication device including a receiving unit to receive a request over a communication network, the request including an indication of the geographical position of another wireless communication device, an indication of the category of information being requested, and a trigger to initiate a search of information accessible to the wireless communication device; a detecting unit to detect the trigger in the request; a searching unit to search a memory for the requested information when the trigger is detected in the request; an extracting unit to extract the requested information from the memory; and a providing unit to send the requested information to the other wireless communication device.

Still another aspect provides, in a wireless communication device, a computer-readable memory having computer-executable instructions. The computer-readable memory includes one or more instructions for receiving a request to provide information to another wireless communication device, the request including an indication of the geographical position of the other wireless communication device, an indication of the category of information being requested, and a trigger to initiate a search of information accessible to the wireless communication device; one or more instructions for detecting the trigger; one or more instructions for automatically searching in a memory for the requested information in response to detecting the trigger using the indication of the category of information and the indication of the geographical position of the other wireless communication device; one or more instructions for extracting the requested information from the memory; and one or more instructions for sending the requested information to the other wireless communication device.

Yet another aspect provides a system comprising a first wireless communication device and a second wireless communication device. The first wireless communication device may calculate the geographical position of the first wireless communication device, and send a request to a second wireless communication device, the request comprising an indication of the geographical position of the first wireless communication device, an indication of a request category associated with the geographical position, and a trigger to automatically initiate a search of information accessible to the second wireless communication device. The second wireless communication device may receive the request, automatically search for the requested information in response to receiving the trigger, extract the requested information, and send the requested information to the first wireless communication device. The first wireless device is further configured to receive from the second wireless communication device the requested information and provide the requested information to a user.

Through the present methods and devices, information associated with a geographical position, which is known to a remote user, may be retrieved and utilized by a first user. The information may be retrieved in a user friendly and almost effortless way by generating a request for certain information at a first wireless communication device and sending the request to at least one second communication device, which may be communicated with through a communication network. Thereby an improved mechanism for facilitating the retrieval of information in a communication system is provided.

An advantage of the present methods and devices is that information may be retrieved in a convenient way, with minimal effort involved both at the sender side and at the recipient side.

### BRIEF DESCRIPTION OF THE DRAWINGS

The present invention will now be described more in detail in relation to the enclosed drawings, in which:

FIG. 1A is a schematic block diagram illustrating a wireless communication network according to an embodiment of the present solution.

FIG. 1B is a schematic block diagram illustrating a wireless communication network according to an embodiment of the present solution.

FIG. 2 is a flow chart depicting a method in a first wireless communication device for retrieving information from a second communication device.

FIG. 3 is a block diagram depicting a first wireless communication device.

FIG. 4 is a flow chart depicting a method in a second communication device for providing information to a first wireless communication device.

FIG. 5 is a block diagram depicting a second communication device.

### DETAILED DESCRIPTION OF PREFERRED EMBODIMENTS

The invention is defined as a method in a first wireless communication device, a first wireless communication device, a method in a second communication device a second communication device and computer programs which may be put into practice in the embodiments described below. This invention may, however, be embodied in many different forms and should not be construed as limited to the embodiments set forth herein; rather, these embodiments are provided so that this disclosure will be thorough and complete, and will fully convey the scope of the invention to those skilled in the art. It should be understood that there is no intent to limit the present method in a first wireless communication device, a first wireless communication device, a method in a second communication device, a second communication device and computer programs to any of the particular forms disclosed, but on the contrary, the present method in a first wireless communication device, a first wireless communication device, a method in a second communication device, a second communication device and computer programs is to cover all modifications, equivalents, and alternatives falling within the scope of the invention as defined by the claims.

Still other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

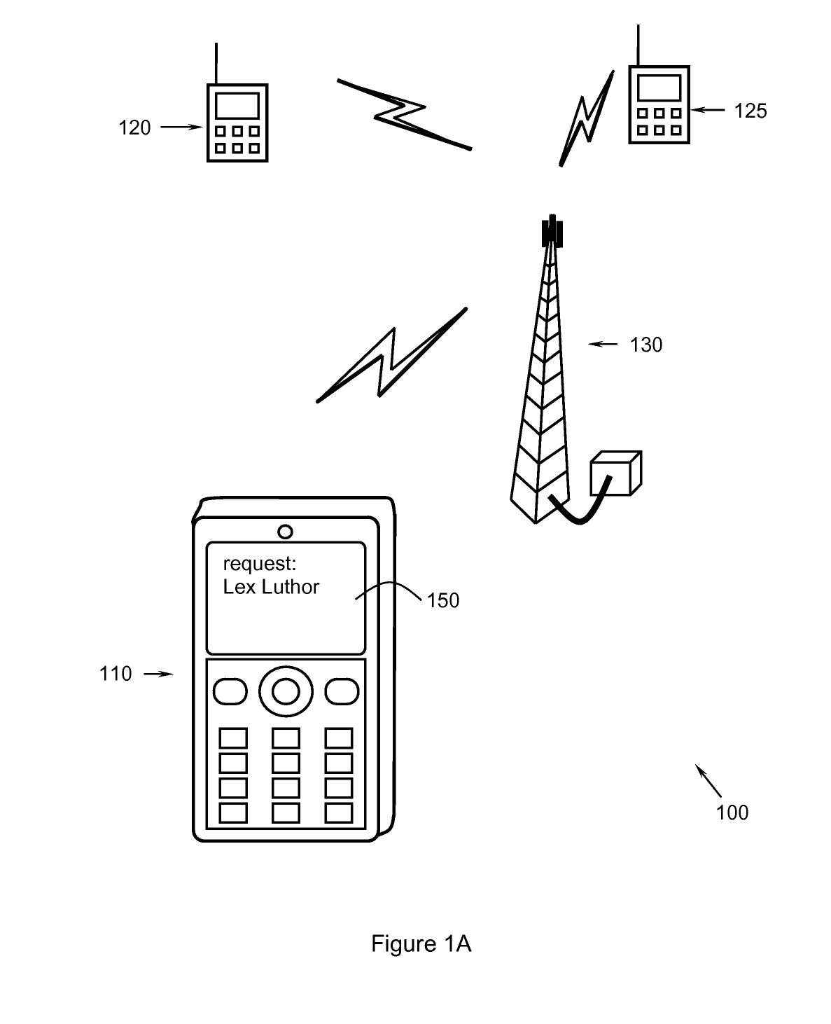

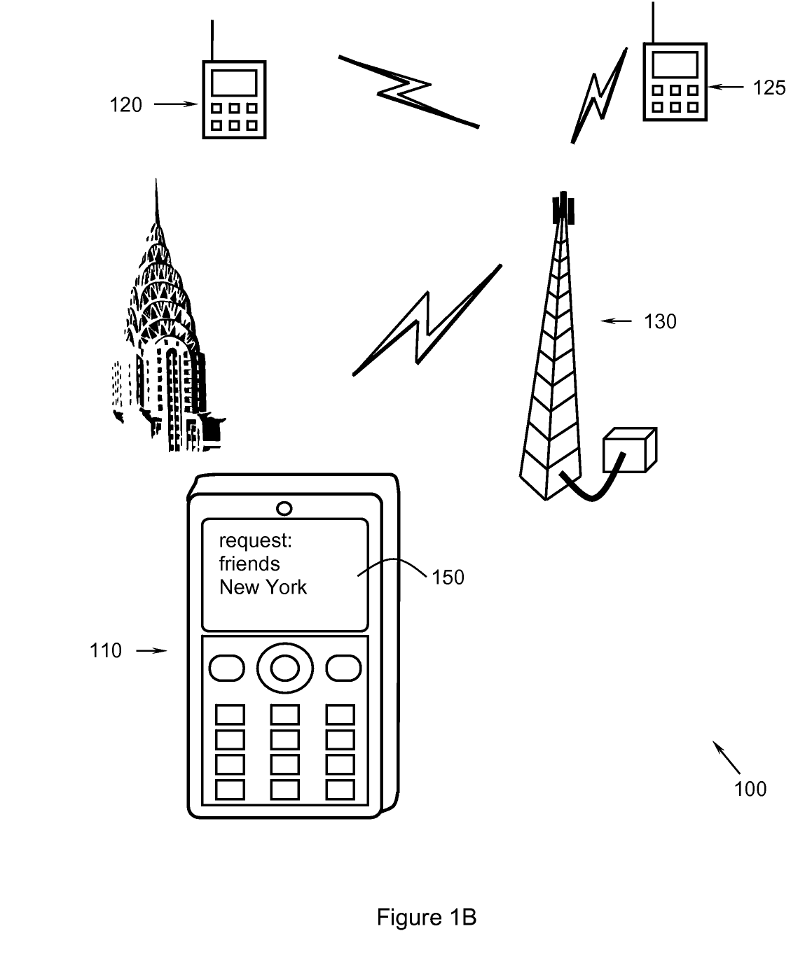

FIG. 1A is a schematic illustration of a first wireless communication device 110 communicating with at least one second communication device 120, 125 in a communication network 100. The communication network 100 may be a wireless or wired communication network 100. When the communication network 100 is a wireless communication network 100, the communication between the first wireless communication device 110 and the second communication device 120, 125 is made over a radio link and may be made over a base station 130 in a cell included in the wireless communication network 100.

Although only one single base station transceiver 130 is shown in FIG. 1A, it is to be understood that many base station transceivers 130 may be connected through, for example, a mobile switching centre and other devices, to define a wireless communication network 100.

In some embodiments, the first wireless communication device 110 may be a user equipment such as a mobile cellular telephone, a Personal Digital Assistant (PDA), a laptop, a computer or any other kind of device capable of wireless communication.

In some embodiments, the second communication device 120, 125 may be a user equipment such as a mobile cellular telephone, a Personal Digital Assistant (PDA), a laptop, a computer or any other kind of device capable of wired or wireless communication.

The communication network 100 may be a wireless communication network 100, based on technologies such as e.g. Code division multiple access (CDMA), Wideband Code Division Multiple Access (WCDMA), CDMA 2000, High Speed Downlink Packet Data Access (HSDPA), High Speed Uplink Packet Data Access (HSUPA), High Data Rate (HDR) etc.

It will be understood that as wireless technologies evolve, so do “wireless communication networks.” As used herein, wireless communication network 100 may refer to various radio access technologies in the traditional sense, a wireless local area network (LAN) or a wireless personal area network without departing from the teachings of the present invention. These networks 100 may include, for example, radio access technologies, such as Enhanced Data rates for GSM Evolution (EDGE), General Packet Radio Service (GPRS), Global System for Mobile Telecommunications (GSM), High Speed Packet Data Access (HSPA), Universal Mobile Telecommunications System (UMTS) and/or Wireless Local Area Networks (WLAN), such as Wireless Fidelity (WiFi) and Worldwide Interoperability for Microwave Access (WiMAX), Bluetooth or according to any other wireless communication standard.

It is to be noted however, that the invention is not in any way limited to be performed exclusively in a wireless communication network 100, but may be performed in a network 100 wherein some nodes are wirelessly connected and some nodes have a wired connection.

The first wireless communication device 110, which may be a portable communication device such as a mobile cellular telephone and may include e.g. a keypad, a camera module, a speaker, a microphone, a transceiver, and a memory, any of which may communicate with a controller e.g. a processor and a display. Furthermore, the first wireless communication device 110 also includes a geographical positioning unit such as a Global Positioning System (GPS) unit, or similar unit for geographical orientation.

The geographical positioning unit such as e.g. a GPS unit is physically included within the first wireless communication device 110, or external to the first wireless communication device 110 but communicating with the first wireless communication device 110 for example by using an identifiable short range radio device e.g. a Bluetooth connection, a wired connection or other suitable means for communication exchange.

Furthermore, the first wireless communication device 110 may, according to some embodiments use cell ID instead of the GPS unit or as a complement to the GPS unit. The control unit may be any commercially available or custom microprocessor, e.g. a Central Processing Unit (CPU), a Peripheral Interface Controller (PIC) microcontroller or any other appropriate device adapted to interpret computer program instructions and process data.

Furthermore, as used herein, “localization” of a geographical position refers to receiving coordinates from, for example, the GPS, and checking e.g. against a list which domain the coordinates belongs to. The domain may be a city, a part of a city, a street, a bar, a suburb, a country, a continent, etc.

The first wireless communication device 110 is able to generate a request 150 by sending a text, e.g. a Short Message Service (SMS), Multimedia Messaging Service (MMS), electronic mail (e-mail), letter, note, Bluetooth broadcast or similar message. The request 150 may be selected from a list of prewritten requests by the user and may be displayed on the display of the first wireless communication device 110. The request 150 according to the invention may include e.g. a tag identifying the request 150 as a request, a tag identifying the type of request, the geographical position of the first wireless communication device 110, a trigger, which trigger initiates the second communication device 120, 125 to start a search for the requested information in an information data base including information data associated with a geographical position, accessible to the second communication device 120, 125. The request may concern one or more particular category of information, e.g. a name, a family name, a company name, a telephone number, an address, an email address, a web address, a geographical location, environmental information or geographical position coordinates.

Some non-limiting examples of scenarios wherein the present methods and devices may be used will now be explained more in detail. According to a first example, a user, having access to the first wireless communication device 110, may want to have contact information such as e.g. telephone number or email address, to a specific person, e.g. Lex Luthor, whom the first user suspects to dwell in the local geographical surroundings.

The first user may suspect that Lex Luthor may be known by some of his/her colleagues. In such a scenario, he/she send a request 150 to all his/her colleagues, requesting them to return contact information concerning Lex Luthor. The request 150 may be sent by means of an SMS, e.g. a special form of SMS. However, the request may alternatively be sent e.g. as an MMS, an e-mail or a Bluetooth broadcast, just to mention some examples of messaging possibilities between the first wireless communication device 110 and the second communication device 120, 125.

The request 150 may be sent to one or more second communication devices 120, 125. The user of the first wireless communication device 110 may select to which of the second communication devices 120, 125 the request 150 is to be sent, from his/her telephone book, from an address list, a list of contacts or similar. Alternatively the telephone numbers or email addresses of the second communication devices 120, 125 may be manually inserted by the user of the first wireless communication device 110

The request 150 includes a tag, identifying the request 150 as a request, not mixing it with a normal SMS. The tag may be e.g. the word “request”, or any other convenient formulation. Further, the request 150 may include the name of the person for whom contact information is requested. The name may be the first name, the family name, a nick name, a name of a company, a name of an organisation etc. Also, the request 150 includes a trigger, which trigger automatically will initiate a search for the requested information data in a data base including information data associated with a geographical position, at the recipient side when detected. The trigger may be e.g. a word, a sequence of signs such as two question marks in a row (“??”) or included implicitly within the word “request”, or any other convenient formulation.

When the second communication device 120, 125 receives the request 150, firstly the request 150 may be identified as a request. When the trigger to start a search is detected, a search for the requested information data is started. Then, a search may be performed in the register and/or data base accessible to the second communication device 120, 125. The data base includes information data associated with a geographical position. Thus a parsing against the content of the register and/or data base accessible to the second communication device 120, 125 may be performed. If a match is found, the attention of the user of the second communication device 120, 125 may be called, according to some embodiments. Such attention may be performed by means of e.g. alert signal in combination with a message. The message may include a text informing the user of the second communication device 120, 125 that the user of the first wireless communication device 110 has requested information data concerning the second communication device 120, 125, and asking permission for forwarding the requested information to the first wireless communication device 110. In case of several matches, the user of the second communication device 120, 125 may select the contact that most likely matches the requested person. If approved by the user of the second communication device 120, 125, the contact information may be sent over to the user of the first wireless communication device 110 such as e.g. a normal contact card would be over SMS.

By making it possible to SMS a contact request 150 to a second communication device 120, 125, the first wireless communication device 110 may be able to look up possible contacts that match the request 150. Also, a simplified way for the user of the second communication device 120, 125 of accepting/rejecting the request 150 and sending the information, or denying the request 150 is achieved. If the user of the second communication device 120, 125 rejects the request, no information is sent to the first wireless communication device 110.

According to some embodiments of the present method, the situation however may be the opposite. The first user, having access to the first wireless communication device 110, may know a telephone number, an email address, etc. but do not recognise or remember the holder of the number or address. He/she may then send the enigmatic telephone number in a request 150 to his/her friends at the second communication device 120, 125. At the second communication device 120, 125, the respective telephone book may be searched e.g. parsed against the telephone number and if a hit is found, the name of the holder of the telephone number in question may be returned in a message to the user of the first wireless communication device 110, provided that the user of the second communication device 120, 125 allow the forwarding of this information.

An advantage with the invention according to this embodiment is that the possessor of a telephone number may be retrieved, even if the telephone number is a protected or non publicly available telephone number.

FIG. 1B depicts a scenario, wherein the present methods and devices according to some optional embodiments may be used. The illustrated scenario is as follows. A user of the first wireless communication device 110 is on travel to New York, USA. The user of the first wireless communication device 110 may not know anyone in New York and may visit the city for the first time. Thus he/she may want to get in contact with any of his/her friend's friends who live in New York.

According to an embodiment of the present method, the contact information, such as e.g. telephone number or email address, for a friend's friend who stays or resides in the surroundings of the geographical position of the user of the first wireless communication device 110 may be requested by sending a request 150 to the second communication devices 120, 125 belonging to the first user's friends.

The request 150 may be sent by means of an SMS. However, the request 150 may alternatively be sent e.g. as an MMS, an e-mail or a Bluetooth broadcast, or in any other convenient way.

The request 150 may be sent to one or more second communication devices 120, 125. The request 150 may include a tag, identifying the request 150 as a request, distinguishing request 150 from other messages being sent by the same means so as to not have the request mixed with a normal message, e.g. SMS. The tag may be e.g. the word “request”, or any other convenient formulation. The request 150 further includes a geographical location, environmental information or geographical position coordinates. According to some embodiments, the GPS information may be used to find out the geographical location, e.g. city, such as e.g. New York the first wireless communication device 110 currently is in. A resulting location specification may be generated and included within the request 150 as depicted in FIG. 1B. Further, the request 150 may include a tag identifying the type of request, here the wording “friends” for identifying the request 150 as a request for friends who live in New York. The request 150 also includes a trigger. The trigger may be any arbitrary word, sign, number or combination thereof. The trigger initiates the recipient of the request, the second communication device 120, 125 to automatically start a search for the requested information data.

It is to be noted that the geographical information that is detected and placed into the request 150, may have to be analysed and/or categorized and/or interpreted and/or converted before it could be used in the request 150. For example, the GPS information that is put into the request 150 in the example above does not include the latitude/longitude coordinates, but rather an interpretation of what city is situated on those coordinates. This is made in order to enhance readability but also the granularity of the geographical position.

As an example, if the GPS coordinates N59°119.80012 and E018°4.2 may be received, these may be parsed against a list of localities with their coordinates and the extracted relevant information from such a parsing may be “Stockholm”, “city centre” or “central station” depending on the dissolution and/or user selection. Thus the precision of the natural language denomination corresponding to a detected position data may depend on user selection.

However, there may be situations when it is preferred to send the detected relevant information without analysis and/or categorization and/or interpretation and/or conversion.

When the second communication device 120, 125 receives the request 150, firstly the request 150 may be identified as a request. Also the type of the request, such as which information is requested, may be identified. In this example, the type of request is friends in New York. When the trigger is detected, the second communication device 120, 125 initiates a search for the requested information data in a data base including information data related to a geographical position.

Thus, a search may be performed in a register and/or data base accessible to the second communication device 120, 125. A parsing against the content of the register and/or data base accessible to the second communication device 120, 125 may be performed, based on the geographical position of the first wireless communication device 110. If a match is found, a person included in the register and/or data base with an address in New York or a New York telephone number, the attention of the user of the second communication device 120, 125 may be called. Such attention may be performed by means of e.g. alert signal in combination with a message, or in any other convenient way. The message may include a text informing the user of the second communication device 120, 125 that the user of the first wireless communication device 110 has requested information data concerning the second communication device 120, 125, and that such requested information data has been found. Also, permission may be asked for forwarding the requested information to the first wireless communication device 110. The user of the second communication device 120, 125 may also be given the opportunity to edit the answer to the request 150 before it is sent. The found contact information may e.g. be obsolete and/or erroneous. The found contact information may also be incomplete. According to some embodiments, the found contact information may be completed by information found on another external data base including other information data e.g. over an Internet connection such as a public telephone register with Internet access.

If approved by the second user, the contact information may be sent over to the user at the first wireless communication device 110 such as e.g. a normal contact card would be over SMS.

An advantage of the present method according to some embodiments is that the user of the first wireless communication device 110 may receive a plurality of contact information messages to friend's friends who live in a particular site the user visits, e.g. New York.

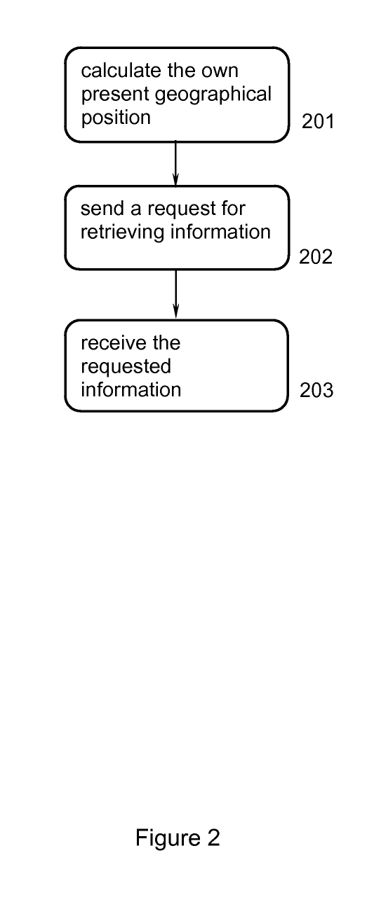

FIG. 2 is a flow chart illustrating a method in the first wireless communication device 110 for retrieving information data from the second communication device 120, 125. As mentioned above, the first wireless communication device 110 and the second communication device 120, 125 are adapted to communicate with each other in the communication network 100. The first wireless communication device 110 includes a geographical positioning unit 330. The second communication device 120, 125 may have access to an information data base including information data associated with a geographical position.

To appropriately retrieve information data from the information data base including information data associated with a geographical position, accessible to the second communication device 120, 125, the method may include a number of steps 201-203. It is however to be noted that some of the described method steps are optional and only included within some embodiments. Further, it is to be noted that the method steps 201-203 may be performed in another chronological order and that some of them, e.g. step 201 and step 202, or even all steps may be performed simultaneously or in an altered, arbitrarily rearranged, decomposed or even completely reversed chronological order. The method may include the following steps:

### Step 201

The geographical positioning unit 330 calculates 201 the position of the first wireless communication device 110. The geographical positioning unit 330 may be a GPS unit, adapted to determine the geographical position of the first wireless communication device 110.

### Step 202

The first wireless communication device 110 sends a request 150 for retrieving information data. The request 150 is sent from the first wireless communication device 110 to the second communication device 120, 125. The request 150 for retrieving information data may be sent by means of an SMS, an MMS, e-mail, Bluetooth or any other convenient communication format.

Before the request 150 is sent, the request 150 may be composed. The composition of the request 150 may optionally be made automatically, semi automatically or manually.

The request 150 thus may be composed automatically such that the user of the first wireless communication device 110 just has to initiate the generation of the request 150, e.g. by pressing a physical key on the keyboard of the first wireless communication device 110, by pressing a soft key displayed on a screen included within the first wireless communication device 110 or by pressing an accord of keys on the keyboard of the first wireless communication device 110. Certain information such as a request tag and the geographical position of the first wireless communication device 110 may be incorporated automatically in the request, without further manual input from the user. Also a trigger may be incorporated in the request without manual input from the user. However, according to some other embodiments, the request is generated manually by the user of the first wireless communication device 110.

The request 150 may be composed by adding a request tag and a trigger to the request 150. Further, information data may be added to the request 150. The information data may include at least one data out of the group: a name, a family name, a company name, a telephone number, an address, an email address, a web address, a geographical location or geographical position coordinates.

Also, a recipient, or a group of recipients, of the request 150 for retrieving information data may be selected before the request 150 is sent. The recipient thus may be one recipient or a plurality of recipients, e.g. all recipients listed in the telephone register of the first wireless communication device 110. The recipients includes at least one second communication device 120, 125, to receive the request 150 for retrieving information data.

### Step 203

The first wireless communication device 110 receives the requested information data associated with the calculated position, from the second communication device 120, 125. The second communication device 120, 125 retrieved the requested information associated with the calculated position, when searching through the information data base accessible to the second communication device.

The requested information data may be received by means of an SMS, an MMS, e-mail, Bluetooth or any other convenient communication format.

The first wireless communication device 110 may receive a plurality of requested information data from different communication devices 120, 125. The first wireless communication device 110 may receive requested information data from a plurality of second communication devices 120, 125.

According to some embodiments, the information data received from the second communication device 120, 125 includes the detected geographical position of the second communication device 120, 125. The control unit 310 included within the first wireless communication device 110 may then calculate the distance between the own detected geographical position of the first wireless communication device 110 and the received geographical position of the second communication device 120, 125. The distance may be calculated in length and/or in time.

According to some embodiments, the control unit 310 included within the first wireless communication device 110 may further compute a convenient meeting place situated in between the first wireless communication device 110 and the second communication device 120, 125.

According to some embodiments, the received positions of the second communication device 120, 125 may be presented on a display included within the first wireless communication device 110. Thus the instantaneous position of the second communication device 120, 125 may be presented at the first wireless communication device 110.

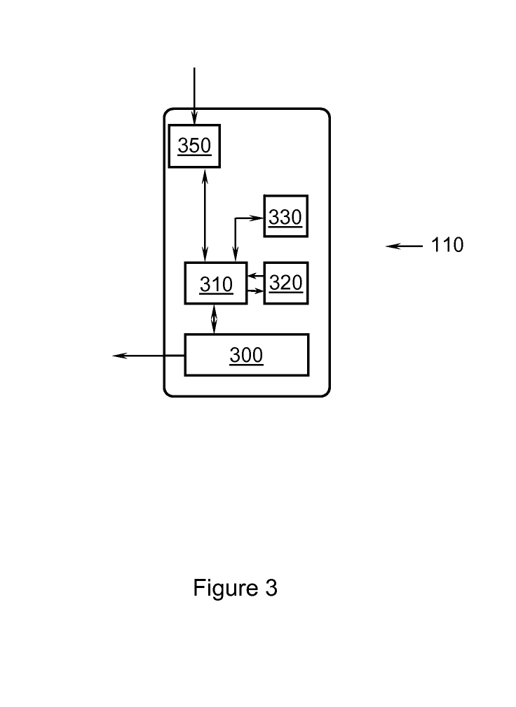

FIG. 3 schematically depicts an embodiment of a first wireless communication device 110 adapted to perform the above described method steps 201-203. The first wireless communication device 110 includes e.g. a sending unit 300, a receiving unit 350 and a memory 320, any of which may communicate with a control unit 310 e.g. a processor. Furthermore, the first wireless communication device 110 also includes a geographical positioning unit 330, such as a GPS unit, or similar unit for geographical orientation and positioning.

For the sake of clarity and in order not to render unnecessary aggravating circumstances for the uninitiated reader to comprehend the present first wireless communication device 110, any internal electronics of the first wireless communication device 110, not necessary for performing the present method according to steps 201-203 has been omitted from FIG. 3.

The sending unit 300 is adapted to send a request 150 for retrieving information data, to at least one second communication device 120, 125. The receiving unit 350 is adapted to receive the requested information data from at least one second communication device 120, 125.

The first wireless communication device 110 is adapted to retrieve information data from a second communication device 120, 125. The first wireless communication device 110 and the second communication device 120, 125 are also adapted to communicate with each other in a communication network 100. The communication network 100 may be a wireless communication network 100.

The control unit 310, which may be included within the first wireless communication device 110 according to some embodiments, may be a Central Processing Unit (CPU), a microprocessor, a Peripheral Interface Controller (PIC) microcontroller or any other appropriate device which may be adapted to interpret computer program instructions and processes data.

The optional memory unit 320, which is included within the first wireless communication device 110 according to some embodiments may be a primary storage memory unit such as a processor register, a cache memory, a Random Access Memory (RAM) or similar. The memory unit 320 may however in some embodiments be a secondary memory unit such as a Read Only Memory (ROM), Electrically Erasable Programmable Read-Only Memory (EEPROM), programmable read-only memory (PROM) or erasable programmable read-only memory (EPROM) or a hard disk drive. The memory unit 320 may however in some embodiments be an off-line storage memory unit, a flash memory, a USB memory or a memory card. The memory unit 320 may in some embodiments be a Network-attached storage (NAS) or in fact any other appropriate medium such as a disk or a tape that can hold machine readable data.

The control unit 310 may according to some embodiments be adapted to generate or at least prepare a request 150, when the user trigger the control unit 310 to generate or at least prepare a request 150.

Furthermore, the first wireless communication device 110 includes a geographical positioning unit 330 such as a GPS unit, or similar unit for geographical orientation, which also may communicate with the control unit 310. According to some embodiments, cell ID may be used instead of the GPS unit 330 or as a complement to the GPS unit 330.

Furthermore, as used herein, “localization”, or calculation of a geographical position refers to receiving coordinates from, for example, the GPS, and checking e.g. against a list which domain the coordinates belongs to. The domain may be a city, a part of a city, a street, a bar, a suburb, a country, a continent, etc.

Although the geographical positioning unit 330, e.g. a GPS unit, is illustrated as included within the first wireless communication device 110 in FIG. 3, embodiments of the present invention are not limited to this configuration. For example, the geographical positioning unit 330 may be external to the first wireless communication device 110 without departing from the scope of the present invention. The geographical positioning unit 330 may communicate with the first wireless communication device 110 via, for example, Bluetooth, a wired connection or any other suitable means for communication and/or exchange of data.

The first wireless communication device 110 may be represented by a portable communication device such as a mobile cellular telephone. This may be an advantage in particular when operating in a wireless communication network 100.

According to some embodiments, the control unit 310 included within the first wireless communication device 110 may be adapted to calculate the distance between the own detected geographical position of the first wireless communication device 110 and the received geographical position of the second communication device 120, 125, as the second communication device 120, 125 according to some embodiments may be adapted to detected the geographical position of the second communication device 120, 125 and send geographical position information to the first wireless communication device 110. The control unit 310 included within the first wireless communication device 110 may then compare and compute the difference in distance, in length and/or time, between the received geographical position of the second communication device 120, 125 and the own geographical position of the first wireless communication device 110. According to some embodiments, the control unit 310 included within the first wireless communication device 110 may be further adapted to compute a convenient meeting place situated in between the first wireless communication device 110 and the second communication device 120, 125.

The sending unit 300 and the receiving unit 350 may according to some embodiments be included within one physical unit, a transceiver 300, 350 which may include a transmitter circuit 300 and a receiver circuit 350, which respectively transmits outgoing radio frequency signals to the base station transceiver 130 and receives incoming radio frequency signals, such as voice call and data signals, from the base station transceiver 130 via an antenna. The antenna may be an embedded antenna, a retractable antenna or any antenna known to those having skill in the art without departing from the scope of the present invention. The radio frequency signals transmitted between the first wireless communication device 110 and the base station transceiver 130 may include both traffic and control signals e.g., paging signals/messages for incoming calls, which are used to establish and maintain a voice call communication with another party or to transmit and/or receive data, such as SMS, e-mail or MMS messages, with a second device 120, 125. The processor 310 may support various functions of the first wireless communication device 110, including functions related to the geographical positioning unit 330, which may be included within the first wireless communication device 110 according to some embodiments of the present invention.

It is to be noted that the described units 300-350 included within the first wireless communication device 110 are to be regarded as separate logical entities but not with necessity separate physical entities. Any, some or all of the units 300-350 may be included or co-arranged within the same physical unit. However, in order to facilitate the understanding of the functionality of the first wireless communication device 110, the included units 300-350 are illustrated as separate physical units in FIG. 3.

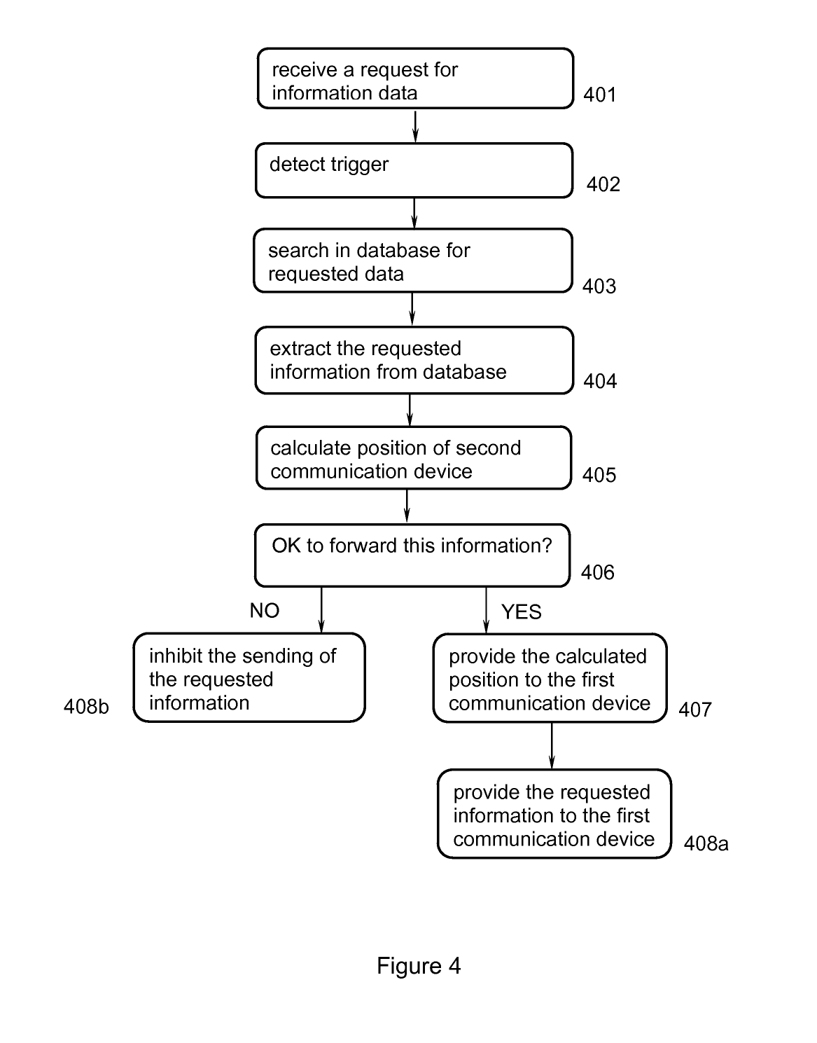

FIG. 4 is a flow chart illustrating a method in the second communication device 120, 125 for providing information data to a first wireless communication device 110. The first wireless communication device 110 and the second communication device 120, 125 are adapted to communicate with each other in a communication network 100. The second communication device 120, 125 has access to an information data base 520 including information data associated with a geographical position.

To appropriately provide information data to the first wireless communication device 110, the method may include a number of steps 401-408. It is however to be noted that some of the described method steps are optional and only included within some embodiments. Further, it is to be noted that the method steps 401-408 may be performed in any arbitrary chronological order and that some of them, e.g. step 402 and step 403, or even all steps may be performed simultaneously or in an altered, arbitrarily rearranged, decomposed or even completely reversed chronological order. The method may include the following steps:

### Step 401

The second communication device 120, 125 receives a request 150 from the first wireless communication device 110 to provide information data to the first wireless communication device 110.

The request 150 includes a geographical position of the first wireless communication device 110 and a trigger to search through the information data base accessible to the second communication device 120, 125 for the requested information data associated with the geographical position of the first wireless communication device 110. The request 150 may further include a tag or reference, identifying the request 150 as a request.

### Step 402

The second communication device 120, 125 detects 402 the trigger and the requested information data. The trigger and the requested information data may be included within the request 150.

### Step 403

The second communication device 120, 125 initiates a search 402 in a data base 520 for the requested information data. The search is initiated automatically when the trigger is detected. The data base 520 may be included within the second communication device 120, 125 or, according to some embodiments, be external to the second communication device 120, 125 but accessible through a communication connection, e.g. accessible over an internet connection.

### Step 404

The requested information is extracted from the data base 520. A prerequisite is that the requested information data is found within the data base 520.

### Step 405

This step is optional and may only be performed within some embodiments. According to some optional embodiments, the second communication device 120, 125 includes a geographical positioning unit 530, such as e.g. a GPS unit.

The geographical positioning unit 530 calculates the position of the second communication device 120, 125. This calculation of geographical position may be made by measuring the position of the device in relation to a number of satellites, e.g. four satellites.

### Step 406

This step is optional and may only be performed within some embodiments. The user of the second communication device 120, 125 may be alerted and/or invited to approve the providing, or sending of the requested information data to the first wireless communication device 110, before sending the requested information data to the first wireless communication device 110. This invitation may be performed by generating and displaying a question for the user on the display of the second communication device 120, 125, encouraging the user to permit or not permit the user of the first wireless communication device 110 to retrieve the requested information data.

### Step 407

This step is optional and may only be performed within some embodiments. The geographical position of the second communication device 120, 125, calculated by the geographical positioning unit may optionally be added to the requested information data which is to be sent to the first wireless communication device 110.

### Step 408a

The requested information data is then provided to the first wireless communication device 110.

### Step 408b

This step is optional and may only be performed within some embodiments. The sending of the requested information data to the first wireless communication device 110 may be inhibited if the sending is not approved by the user of the second communication device 120, 125.

Due to the present method, information may be retrieved and provided to a remote first user in a convenient way, with a minimum of exertion involved.

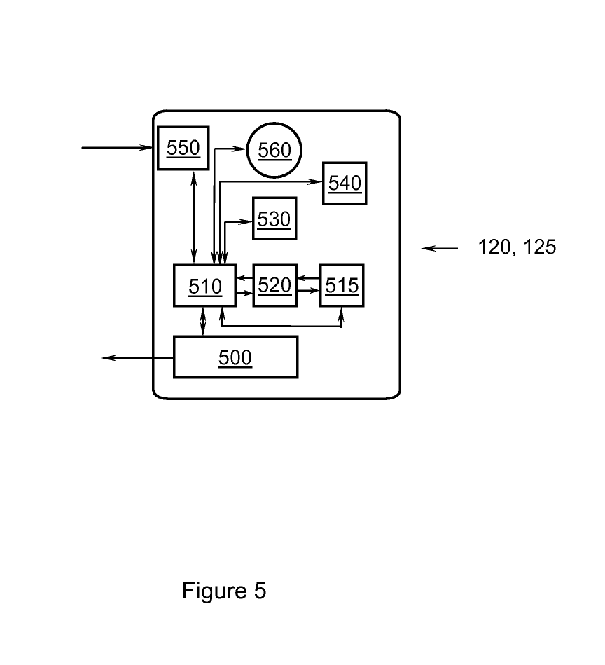

FIG. 5 schematically depicts an embodiment of a second communication device 120, 125 including e.g. a providing unit 500, a searching unit 510 e.g. a control unit, a detecting unit 515, an optional memory unit 520, an extracting unit 540 and a receiving unit 550. Furthermore, the second communication device 120, 125 also may optionally include a geographical positioning unit 530 such as a GPS unit, or similar unit for geographical orientation. However, according to some embodiments, the second communication device 120, 125 may not include a geographical positioning unit 530 e.g. a GPS unit. Further, the second communication device 120, 125 optionally may include a camera unit 560. The second communication device 120, 125 is adapted to communicate with the first wireless communication device 110 in a communication network 100. The communication network 100 may be a wireless network or a partly wireless network. The second communication device 120, 125 has access to an information data base 520 including information data associated with a geographical position.

For the sake of clarity and in order not to render unnecessary aggravating circumstances for the uninitiated reader to comprehend the present second communication device 120, 125, any internal electronics of the second communication device 120, 125, not completely necessary for performing the present method according to steps 401-408 have been omitted from FIG. 5.

The receiving unit 550 is adapted to receive the request 150 for providing information data from the first communication device 110. The searching unit 510 is adapted to search in a data base 520 for the requested information data. The extracting unit 540 is adapted to extract the requested information data from the data base 520, which data base 520 include information data related to a geographical position. The providing unit 500 is adapted to send the requested information data to the first wireless communication device 110.

The searching unit 510, which is included within the second communication device 120, 125 may be a control unit such as a Central Processing Unit (CPU), a microprocessor, a Peripheral Interface Controller (PIC) microcontroller or any other appropriate device adapted to interpret computer program instructions and processes data.

The detecting unit 515 is adapted to detect a trigger and the requested information data included in the received request 150.

The optional memory unit 520, which may be included within the second communication device 120, 125 according to some embodiments may be a primary storage memory unit such as a processor register, a cache memory, a Random Access Memory (RAM) or similar. The optional memory unit 520 may however in some embodiments be a secondary memory unit such as a Read Only Memory (ROM), Electrically Erasable Programmable Read-Only Memory (EEPROM), programmable read-only memory (PROM) or erasable programmable read-only memory (EPROM) or a hard disk drive. The optional memory unit 520 may however in some embodiments be an off-line storage memory unit, a flash memory, a USB memory or a memory card. The optional memory unit 520 may in some embodiments be a Network-attached storage (NAS) or in fact any other appropriate medium such as a disk or a tape that can hold machine readable data.

Furthermore, the second communication device 120, 125 may also include an optional geographical positioning unit 530 such as a GPS unit, or similar unit for geographical orientation, which also may communicate with the control unit 510. According to some embodiments, cell ID may be used instead of the optional GPS unit 530 or as a complement to the optional GPS unit 530.

It will be understood that although some embodiments of the present invention are discussed herein with respect to GPS, embodiments of the present invention are not limited to such configuration. Furthermore, as used herein, “localization” of a geographical position refers to receiving coordinates from, for example, the GPS, and check e.g. against a list which domain the coordinates belongs to. The domain may be a city, a part of a city, a street, a bar, a suburban, a country, a continent etc.

Although the optional geographical positioning unit 530, e.g. a GPS unit, is illustrated as included within the second communication device 120, 125 in FIG. 5, embodiments of the present invention are not limited to this configuration. For example, the optional geographical positioning unit 530 may be external to the second communication device 120, 125 without departing from the scope of the present invention. The optional geographical positioning unit 530 may communicate with the second communication device 120, 125 via, for example, Bluetooth, a wired connection or any other suitable means for communication and/or exchange of data.

Further, the second communication device 120, 125 may, according to some optional embodiments, further includes a camera unit 560 adapted to take photos. The photos taken by the camera unit 560 may according to some embodiments be associated with the geographical position where the photo was taken, which geographical position is detected by the geographical positioning unit 530. Thus the photos taken with the camera unit 560 may be associated with a geographical position.

The second communication device 120, 125 may be represented by a portable communication device such as e.g. a mobile cellular telephone. This may be an advantage in particular when operating in a wireless communication network 100.

The sending unit 500 and the receiving unit 550 may according to some embodiments be included within one physical unit, a transceiver 500, 550 which may include a transmitter circuit 500 and a receiver circuit 550, which respectively transmits outgoing radio frequency signals to the base station transceiver 130 and receives incoming radio frequency signals, such as voice call and data signals, from the base station transceiver 130 via an antenna. The antenna may be an embedded antenna, a retractable antenna or any antenna known to those having skill in the art without departing from the scope of the present invention. The radio frequency signals transmitted between the second communication device 120, 125 and the base station transceiver 130 may include both traffic and control signals e.g., paging signals/messages for incoming calls, which are used to establish and maintain a voice call communication with another party or to transmit and/or receive data, such as SMS, e-mail or MMS messages, with a remote device 110. The processor 510 may support various functions of the second communication device 120, 125, including functions related to the geographical positioning unit 530 which may be included within the second communication device 120, 125 according to some embodiments of the present invention.

It is to be noted that the described units 500-560 included within the second communication device 120, 125 are to be regarded as separate logical entities but not with necessity separate physical entities. Any, some or all of the units 500-560 may be included or co-arranged within the same physical unit. However, in order to facilitate the understanding of the functionality of the second communication device 120, 125, the included units 500-560 are illustrated as separate physical units in FIG. 5.

### Computer Programs

The present methods for retrieving information data may be implemented through one or more processors 310 in the first wireless communication device 110, and through one or more processors 510 in the second communication device 120, 125, together with computer program code for performing the functions of the methods. The program code mentioned above may also be provided as a computer program product, for instance in the form of a data carrier carrying computer program code for performing the methods according to the present solution when being loaded into the processor unit. The data carrier may be a CD ROM disc, a memory stick, or any other appropriate medium such as a disk or tape that can hold machine readable data. The computer program code may furthermore be provided as pure program code on a server and downloaded to the first wireless communication device 110 and the second communication device 120, 125 remotely.

Thus a computer readable medium encoded with a computer program for retrieving information data from a second communication device 120, 125 to a first wireless communication device 110 may perform the method steps according to steps 201-203.

Thus also a computer readable medium encoded with a computer program for providing information data from a second communication device 120, 125 to a first wireless communication device 110 may perform the method steps according to steps 401-408.

As will be appreciated by one of skill in the art, the present invention may be embodied as a first wireless communication device 110, a second communication device 120, 125, a method in a first wireless communication device 110, a method in a second communication device 120, 125 or computer program products. Accordingly, the present invention may take the form of an entirely hardware embodiment, a software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present methods may be written in any arbitrary programming language such as Java®, Smalltalk or C++. However, the computer program code for carrying out the steps of the present method may also be written in any conventional procedural programming languages, such as the “C” programming language and/or a lower level assembler language. The program code may execute entirely on the first wireless communication device 110, partly on the first wireless communication device 110, as a stand-alone software package, partly on the first wireless communication device 110 and partly on a remote computing device or entirely on the remote computing device. In the latter scenario, the remote computing device may be connected to the first wireless communication device 110 through a local area network (LAN) or a wide area network (WAN), or the connection may be made to an external computer, for example, through the Internet using an Internet Service Provider.

Furthermore, the present methods were described in part above with reference to flowchart illustrations and/or block diagrams of a first wireless communication device 110, a second communication device 120, 125, methods, and computer program products according to embodiments of the invention. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

### Further Applications of the Present Methods and Devices

According to some embodiments, the present methods and devices may be used for compiling photos from friends, taken in the proximity of the user's position.

Some communication devices 110, 120, 125 may include e.g. a camera, a film camera, GPS functionality and also a possibility to map and store GPS position data for a photo, where the GPS position data indicates the geographical position where the photo was taken, as previously discussed.

The first wireless communication device 110 may generate and send a request 150 to the friends in the phone book of the first wireless communication device 110, using the second communication devices 120, 125, requesting them to send a photo from the position where the first wireless communication device 110 at present is situated. The granularity of the proximity to the present position of the first wireless communication device 110 may be predetermined, or may be user defined. Thus if the first wireless communication device 110 is situated in front of the Chrysler building on Lexington Avenue in New York, it may request photos from the second communication devices 120, 125, taken e.g. at the Chrysler building, taken at Manhattan, taken in New York or taken in USA, for example.

The second communication devices 120, 125 thus receive a request 150 for a photo taken in the proximity of the present position of the first wireless communication device 110. Firstly the request 150 may be identified as a request. Also the type of the request, such as which information is requested, may be identified. In this example, the type of request is photo taken in the proximity of the position of the first wireless communication device 110.

Then, a search may be performed in a register and/or data base 520 such as a photo storage memory area of the second communication device 120, 125. A parsing against the content of the register and/or data base 520, accessible for the second communication device 120, 125 may be performed, based on the geographical position of the first wireless communication device 110. If a match is found, the attention of the user of the second communication device 120, 125 may be called. Such attention may be performed by means of e.g. alert signal in combination with a message, or in any other convenient way. The message may include a text informing the user of the second communication device 120, 125 that the first wireless communication device 110 has requested photo taken by the second communication device 120, 125, and that such requested information data has been found. Also, permission may be asked for forwarding the requested information to the first wireless communication device 110. The user of the second communication device 120, 125 may also be given the opportunity to edit the answer to the request 150 before it is sent. The user of the second communication device 120, 125 may not want to send all encountered photos.

If approved by the second user, the encountered photos may be sent over to the first wireless communication device 110.

An advantage of the described embodiment is that photos from a certain area, taken by different friends may be compiled in an easy way. Further, according to some embodiments, the photos may be associated with a text commenting the objects on the photo. In that way, the user may receive and compile tourist information etc about a certain site. As an example, a photo taken by a friend may depict a restaurant. GPS coordinates may be associated with the picture and a text message of arbitrary format may be associated with the photo. The text may include a recommendation, suggestion, rating etc. Thus according to some embodiments of the present methods and devices, a recipient initiated postcard may be generated.

According to some embodiments, the present methods and devices may be used for receiving travel guidance for a journey from the user's position to a user selected travel target. In a fictitious scenario, the user of the first wireless communication device 110 may be a tourist situated in front of the Chrysler building in New York as previously illustrated in FIG. 1B and wanting to arrive to the Empire State building. The first wireless communication device 110 may then send a request 150 for a travel guide to a second communication device 120 including e.g. a server.

The second communication device 120 may receive the request 150; extract the user's geographical position from the attached GPS data, and compute the fastest and/or most convenient way of travelling by public transport to the indicated destination.

An advantage with the present method according to this embodiment is that information concerning e.g. public transport facilities may be received in a convenient and user friendly way, also at a site which is unknown to the user or where the user has lost his/her way. The present method may facilitate travel and journeys in unfamiliar sites. The present method may also be used e.g. as a way finder, for finding the closest way to civilisation when being lost in a hostile, uninhabited environment e.g. in the woods, etc.

According to some embodiments, the present methods and devices may be used for retrieving e.g. a weather report, tourist information, local news or other similar information relevant for the position of the first wireless communication device 110 such as e.g. a glossary to/from the local language, an updated local currency converter, a local pollen report, information concerning time for sunset/sunrise, the geographical position of local leather blondes, a map over the proximity, a map over the proximity with tourist attractions indicated etc. The first wireless communication device 110 may generate a request 150 for a certain provided service by writing e.g. “weather” in a request 150. The position may be added to the request 150 e.g. by a GPS device included within the first wireless communication device 110.

The thus generated request 150 may then be sent to a second communication device 120, which may be a provider of weather reports and weather forecasts. The second communication device 120 may receive the request 150; extract the user's geographical position from the attached GPS data, and parse the extracted geographical position against a register including weather forecasts for different regions or areas.

The weather report may then be returned to the user of the first wireless communication device 110.

An advantage with the invention according to such an embodiment is that relevant local information may be received by the user in a convenient and close to effortless way.

According to some embodiments, the user of the first wireless communication device 110 may suspect or hope any/some of his/her friends at the present moment is situated in the proximity and want to meet an arbitrary friend e.g. for having lunch together. The first wireless communication device 110 may then generate and send a request 150 to all, some or any of his/her friends retrieved e.g. from the telephone book, requesting their present geographical position. The geographical position of the first wireless communication device 110 may be added to the request 150, e.g. extracted from a GPS unit included in the first wireless communication device 110.

The recipients of the request 150, the second communication devices 120, 125, may answer with a geographical position, provided the user of the second communication device 120, 125 allow that information to be forwarded to the user of the first wireless communication device 110.

An advantage with the present method and device according to the latest described embodiment is that it may facilitate social contacts with friends. This may be useful in particular for keeping in touch with friends when travelling, or moving e.g. in a metropolitan area, but may be useful in any environment. As an example, a casual lunch meeting may be automatically generated at lunch time e.g. each day, with the friend being positioned closest to the first wireless communication device 110. Further, a suggestion for a restaurant situated in between the first wireless communication device 110 and the second communication device 120, 125, may be generated by the first wireless communication device 110 and sent to the second communication device 120, 125. The first wireless communication device 110 may further be adapted to generate and send a table reservation to the restaurant.

According to some embodiments, the first wireless communication device 110 may want to check if any user of a second communication device 120, 125 within close proximity has the contact information e.g. the telephone number to a third person. Such a scenario may occur when visiting a party where the user of the first wireless communication device 110 meet an attractive woman but get interrupted in the conversation with her before capturing her telephone number.

The first wireless communication device 110 may then send a request 150 by means of a Bluetooth broadcast to the second communication device 120, 125 within range, requesting her telephone number from them.

An advantage with the present method and device according to the latest described embodiment is that it may facilitate the initiation of social contacts with new, previously unknown people.

The present method and devices may according to some embodiments be used in a backpacker mode. When travelling for example in South Asia, the traveller may encounter other travellers on his/her way. The travel way of other travellers may later converge with the user's own travel route. The user of the first wireless communication device 110 may then send a request 150 to the acquaintances he/she has made during the travel, which acquaintances are in possession of a second communication device 120, 125, requesting them for their present geographical position. This geographical position may be detected by means of a geographical positioning unit such as e.g. GPS as previously explained. Further, the request 150 may include the geographical position of the user of the first wireless communication device 110.

The respective geographical position of the first user's made acquaintances may then be compiled at the first wireless communication device 110 and presented to the first user. The information may be presented e.g. by indications on a map e.g. presented on the display of the first wireless communication device 110, for enhanced user friendliness. According to some embodiments, a meeting point in between the connected communication devices 110, 120, 125 may be calculated, generated and presented to the respective users, with a suggested meeting date on the suggested meeting point.

The first wireless communication device 110 thus may be configured to compute the distances between the first wireless communication device 110 and the connected second communication devices 120, 125.

The terminology used in the detailed description of the particular exemplary embodiments illustrated in the accompanying drawings is not intended to be limiting of the invention. In the drawings, like numbers refer to like elements.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

The word “information” as used herein is to be understood as meaning not only typographical letters but may also include pictures, images, photos, animations, graphics, maps, multimedia, movies, film sequences, sound, music, spoken words etc. which may be used for presenting a piece of information or a message to a user.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

1. A method performed by a wireless communication device, the method comprising:
calculating the geographical position of the wireless communication device;
sending a request to another wireless communication device, the request comprising an indication of the geographical position of the wireless communication device, an indication of a request category associated with the geographical position, and a trigger to automatically initiate a search of information accessible to the other wireless communication device; and
receiving from the other wireless communication device the requested information associated with the calculated position.

2. The method of claim 1, where the category of information is one or more of a name, a telephone number, an address, an email address, or a geographical location.

3. The method of claim 1, where the request is sent to the other wireless communication device as a Short Messaging Service (SMS) message.

4. The method of claim 1, where the request is sent to the other wireless communication device using Bluetooth protocol.

5. A wireless communication device, comprising:
a geographical positioning unit adapted to determine the geographical position of the wireless communication device;
a sending unit, adapted to send a request for information to at least one other wireless communication device, the request including an indication of the geographical position of the wireless communication device, an indication of a request category associated with the geographical position, and a trigger to automatically initiate a search of information accessible to the at least one other wireless communication device; and
a receiving unit, adapted to receive the requested information from the at least one other wireless communication device.

6. The wireless communication device of claim 5, where the category of information is associated with the geographical position of the wireless communication device.

7. A method performed by a wireless communication device, the method comprising:
receiving a request to provide information to another wireless communication device, the request including an indication of the geographical position of the other wireless communication device, an indication of a request category associated with the geographical position, and a trigger to initiate a search of information accessible to the wireless communication device;
automatically searching for the requested information in response to receiving the trigger;
extracting the requested information; and
sending the requested information to the other wireless communication device.

8. The method of claim 7, further comprising:
inviting a user of the wireless communication device to approve the sending the requested information to the other wireless communication device.

9. The method of claim 7, further comprising:
inhibiting the sending the requested information to the other wireless communication device if the sending is not approved by a user of the wireless communication device.

10. The method of claim 7, further comprising:
calculating the position of the wireless communication device in response to receiving the request; and
providing the calculated position of the wireless communication device to the other wireless communication device.

11. The method of claim 7, where the sending the requested information to the other wireless communication device includes using a Short Messaging Service (SMS).

12. The method of claim 7, where the sending the requested information to the other wireless communication device includes using Bluetooth protocol.

13. The method of claim 7, further comprising:
alerting a user of the wireless communication device of the request to provide information.

14. A wireless communication device, comprising:
a receiving unit to receive a request over a communication network, the request including an indication of the geographical position of another wireless communication device, an indication of the category of information being requested, and a trigger to initiate a search of information accessible to the wireless communication device;
a detecting unit to detect the trigger in the request;
a searching unit to search a memory for the requested information when the trigger is detected in the request;
an extracting unit to extract the requested information from the memory; and
a providing unit to send the requested information to the other wireless communication device.

15. The wireless communication device of claim 14, where the detecting unit associates the geographical position of the other wireless communication device with the category of information being requested.

16. The wireless communication device of claim 14, further comprising:
a geographical positioning unit adapted to determine a geographical position of the wireless communication device.

17. The wireless communication device of claim 16, further comprising:
a camera unit adapted to take photos and store the photos in the memory.

18. The wireless communication device of claim 17, where the photos stored in the memory are associated with the geographical position where the photo was taken, the geographical position being detected by the geographical positioning unit.

19. In a wireless communication device, a computer-readable memory comprising computer-executable instructions, the computer-readable memory comprising:
one or more instructions for receiving a request to provide information to another wireless communication device, the request including an indication of the geographical position of the other wireless communication device, an indication of the category of information being requested, and a trigger to initiate a search of information accessible to the wireless communication device;
one or more instructions for detecting the trigger;
one or more instructions for automatically searching in a memory for the requested information in response to detecting the trigger using the indication of the category of information and the indication of the geographical position of the other wireless communication device;
one or more instructions for extracting the requested information from the memory; and
one or more instructions for sending the requested information to the other wireless communication device.

20. The computer-readable memory of claim 19, further comprising:
one or more instructions for inviting approval of a user of the wireless communication device for sending the requested information to the other wireless communication device.

21. A system comprising:
a first wireless communication device to:
calculate the geographical position of the first wireless communication device, and
send a request to a second wireless communication device, the request comprising an indication of the geographical position of the first wireless communication device, an indication of a request category associated with the geographical position, and a trigger to automatically initiate a search of information accessible to the second wireless communication device; and
a second wireless communication device to:
receive the request,
automatically search for the requested information in response to receiving the trigger,
extract the requested information, and
send the requested information to the first wireless communication device;
where the first wireless device is further configured to receive from the second wireless communication device the requested information and provide the requested information to a user.
